(19) United States
(12) Patent Application Publication
(10) Pub. No.: US 2017/0278098 A1
(43) Pub. Date: Sep. 28, 2017

(54) SECURITY IMPLEMENTATION FOR USER RESOURCE DISTRIBUTION

(71) Applicant: BANK OF AMERICA CORPORATION, Charlotte, NC (US)

(72) Inventors: Joseph Benjamin Castinado, North Glenn, CO (US); Stephen A. Corrado, Marvin, NC (US); Phillip Wade Mork, Huntersville, NC (US); Sasidhar Purushothaman, Manikonda (IN); Evan Sachs, New York, NY (US)

(21) Appl. No.: 15/082,964

(22) Filed: Mar. 28, 2016

(51) Int. Cl. G06Q 20/36; G06Q 20/42

(52) U.S. Cl. CPC G06Q 20/367; G06Q 20/42

(57) ABSTRACT

A system for securely distributing resources includes a smart device and a third party system each having a network communication interface, a memory device and a processing device. In the smart device the processing device is configured to: communicate host information from the smart device to an associated host entity system; and communicate resource distribution information from the smart device to a third party system. The resource distribution information is usable by the third party system to securely distribute a resource from the third party system to the host entity system. In the third party system the processing device is configured to: receive resource distribution information from the smart device where the resource distribution information is used to distribute a resource to the host entity system; and distribute the resource to the host entity system based on the resource distribution information.

### BACKGROUND

Systems for providing device to device communications are known where interconnected devices, sometimes referred to as smart devices, may include communications modules, processors and applications that allow the devices to communicate with one another over a network. Such systems allow the devices to collect and exchange data and are commonly referred to as the internet-of-things.

### BRIEF SUMMARY

Embodiments of the present invention provide an innovative system, method and apparatus for securely distributing a user resource between interconnected devices.

In some embodiments a smart device comprises a network communication interface; a memory device storing a smart device operating application and a resource distribution application; and a processing device operatively coupled to the memory device. The processing device is configured to execute computer-readable program code to: communicate host information from the smart device to a host entity system; and communicate resource distribution information from the smart device to a third party system where the third party system is different than the host entity system, the resource distribution information is used by the third party system to securely distribute a resource from the third party system to the host entity system.

The information may comprise at least one of a usage level and an identification of a renewable product. The resource distribution information may comprise a secured request. The secured request may comprise a request for payment to the host entity system. The secured request may comprise a token. The smart device may comprise a sensor for generating a signal used to initiate the secured request. The computer-readable program code may comprise logic used to initiate the secured request. The host entity system may comprise a financial institution system.

In some embodiments a third party system comprises a network communication interface; a memory device storing a resource distribution application; and a processing device operatively coupled to the memory device. The processing device is configured to execute computer-readable program code to: receive resource distribution information from a smart device associated with a host entity system where the resource distribution information is used to distribute a resource to the host entity system; and distribute the resource to the host entity system based on the resource distribution information.

The resource distribution information may comprise a secured request. The secured request may comprise a request for payment to the host entity system. The secured request may comprise a token. The host entity system may comprise a financial institution system. The distribution may comprise a payment from the third party system to the host system. An acknowledgement message may be received from the host system acknowledging the payment. The payment may be related to at least one of the purchase of a renewable product, a subscription service and a metered charge.

In some embodiments a method for communicating from a smart device is provided comprising: communicating host information from the smart device to a host entity system via a network communication interface; and communicating resource distribution information from the smart device to a third party system via the network communication interface where the third party system is different than the host entity system, the resource distribution information used by the third party system to distribute a resource to the host entity system.

The resource distribution information may comprise a secured request requesting a payment to the host entity system. The method may comprise generating a signal used to initiate the secured request. The method may comprise using logic to initiate the secured request.

In some embodiments a system for providing smart device communication comprises a smart device comprising a network communication interface; a memory device storing a smart device operating application and a resource distribution application; and a processing device operatively coupled to the memory device. The processing device is configured to execute computer-readable program code to: communicate host information from the smart device to a host entity system; and communicate resource distribution information from the smart device to a third party system where the third party system is different than the host entity system, the resource distribution information used by the third party system to securely distribute a resource from the third party system to the host entity system. The system also comprises a third party system comprising a network communication interface; a distributed memory device storing a resource distribution application; a processing device operatively coupled to the memory device. The processing device is configured to execute computer-readable program code to: receive resource distribution information from a smart device associated with a host entity system where the resource distribution information is usable to distribute a resource to the host entity system; and distribute the resource to the host entity system based on the resource distribution information. The resource distribution information may comprise a secured request for payment to the host entity system.

### BRIEF DESCRIPTION OF THE DRAWINGS

FIG. 1 is a block diagram illustrating a system for security implementation for user resource distribution, in accordance with embodiments of the invention;

FIG. 2 is a block diagram illustrating the mobile computing device of FIG. 1, in accordance with embodiments of the invention;

FIG. 3 is a block diagram illustrating the personal computing device of FIG. 1, in accordance with embodiments of the invention;

FIG. 4 is a block diagram illustrating the financial institution system of FIG. 1, in accordance with embodiments of the invention;

FIG. 5 is a block diagram illustrating an exemplary smart device, in accordance with embodiments of the invention;

FIG. 6 is a flowchart illustrating methods for security implementation for user resource distribution in accordance with embodiments of the invention;

FIG. 7 is a flowchart illustrating a method for establishing security implementation for user resource distribution in accordance with embodiments of the invention.

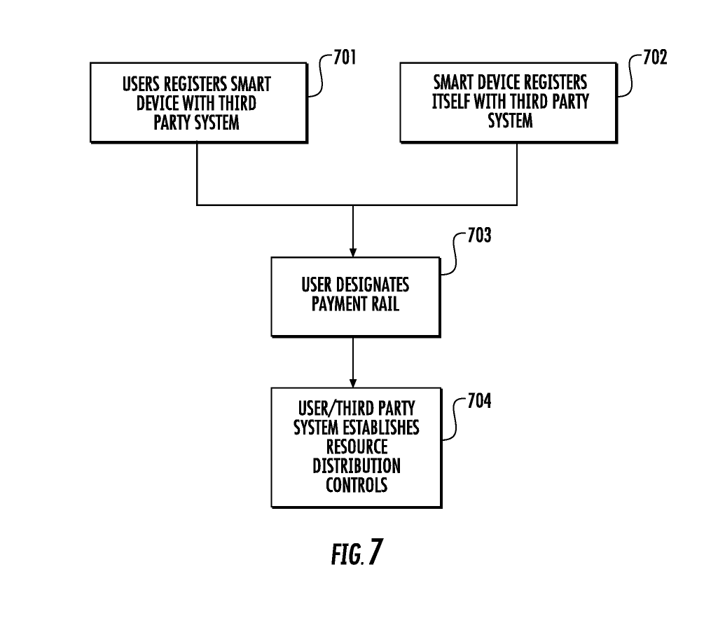

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

In accordance with embodiments of the invention, the terms “financial institution” and “financial entity” include any organization that processes financial transactions including, but not limited to, banks, credit unions, savings and loan associations, investment companies, stock brokerages, asset management firms, insurance companies and the like.

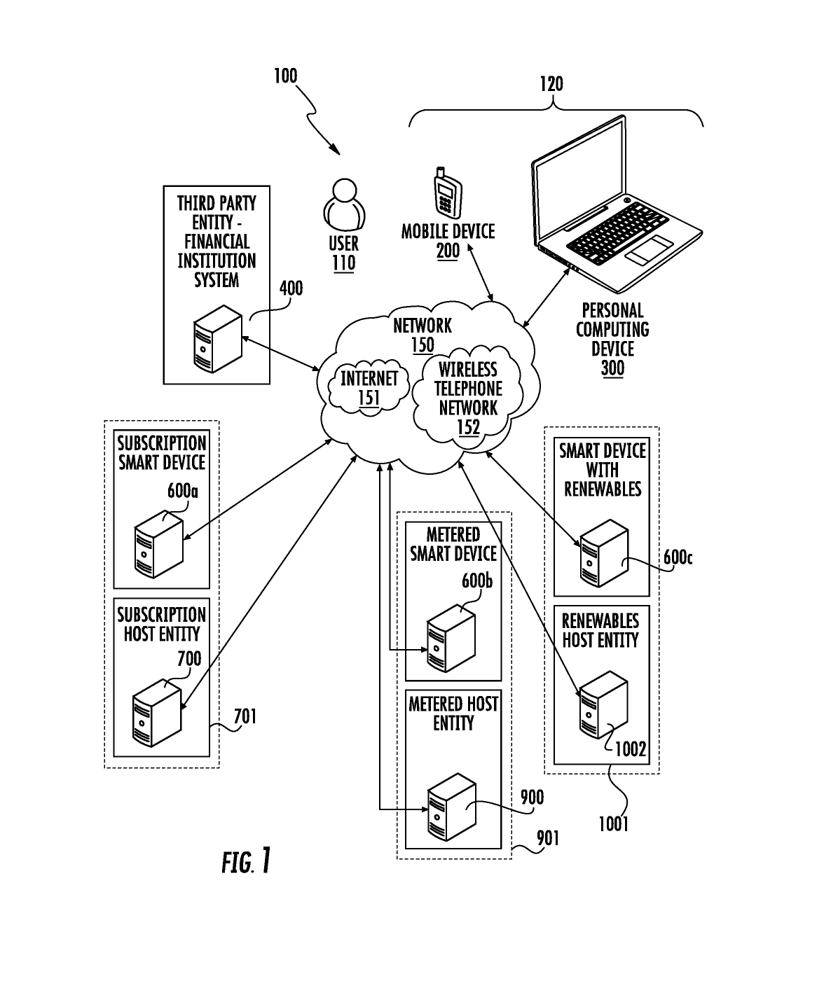

FIG. 1 provides a block diagram illustrating an environment 100 for a system for security implementation for user resource distribution, in accordance with an embodiment of the invention. In some embodiments, the user resource comprises financial assets that are securely distributed in a payment system using smart devices. As illustrated in FIG. 1, the environment 100 includes a user 110 where the user represents a customer having a relationship with at least one but typically more than one financial institution. A user of the system may be a person, but may also be a business or any other entity. In a typical environment thousands of users may access the system of the invention.

The environment 100 also may include a plurality of user devices. The user devices may comprise any machine, apparatus, system or the like that may be connected to and communicate with other devices over network 150. At least one of the devices may comprise a computing device 120 for use by the user 110. The computing device 120 may be any device that employs a processor and memory and can perform computing functions, such as a personal computing device 300 or a mobile device 200, that may be connected to or access network 150. The personal computing device 300 may comprise a personal computer such as a desk top computer, lap top computer, tablet or any type of personal computing device that may be connected to a network by landline or wireless access such as wireless local area network (WLAN) such as WiFi based on the Institute of Electrical and Electronics Engineers' (IEEE) 802.11 standards, Bluetooth short-wavelength UHF radio waves in the ISM band from 2.4 to 2.485 GHz or other wireless access technology. As used herein, the mobile device 200 may comprise any mobile communication device, such as a cellular telecommunications device (i.e., a cell phone or mobile phone), personal digital assistant (PDA), a mobile Internet accessing device, or other mobile device. A mobile device may connect to the network by a cellular telecommunications network or by WiFi, Bluetooth or other access technology. In some embodiments where, for example, the user is an institution the computing device 120 may comprise servers, access terminals, or the like.

The computing device 120 may be configured to communicate over network 150 with at least one third party entity system such as financial institution system 400 of a third party entity such as a financial institution and with one or more smart devices as will hereinafter be described. The network 150 may include a local area network (LAN), a wide area network (WAN), and/or a global area network (GAN). The network 150 may provide for wireline, wireless, or a combination of wireline and wireless communication between devices in the network. In one embodiment, the network 150 includes the Internet 151. In one embodiment, the network 150 may also include a wireless telephone network 152.

In general, the computing device 120 is configured to connect with the network 150 and may be used to log the user 110 into the financial institution system 400 of the third party entity financial institution. A user 110 in order to access the user's account(s) typically uses an online banking application and/or mobile banking application on the financial institution system 400 and must authenticate with the financial institution system 400. For example, logging into the financial institution system 400 generally requires that the user 110 authenticate his/her/its identity using a user name, a passcode, a cookie, a biometric identifier, a private key, a token, and/or another authentication mechanism that is provided by or for the user 110 to the financial institution system 400 via the computing device 120. In some embodiments the authentication system may be a tiered system that may require different levels of authentication based on conditions such as, for example, previous activity of the user over the network 150. For example, the tiered authentication system may have three levels of authentication—hard, medium and soft. Hard authentication may require that the user input a high level of authentication information such as a combination of password, user identification, answer to challenge questions, biometrics, random key number or the like. A hard authentication may be required when the user logs on from an unrecognized user device or where the user activity is not recognized by the system. A medium authentication level may require only a user identification and password. A medium level of authentication may be required where, for example, the user has already logged-in to the computing device 120 using an authentication procedure for the device such as a thumbprint or password. A soft authentication may require only a user identification such as user name. A soft level of authentication may be used, for example, where the user has already logged-in to the computing device 120 using an authentication procedure for the device such as a thumbprint or password and the user has performed activities on the user device that are recognized as “normal” activity for that user and/or the user device is in a recognized location for that user. Thus, the level of authentication required for accessing the banking application, whether online, mobile or in person, may be adjusted based on conditions, activity, functions or information received about or from the user.

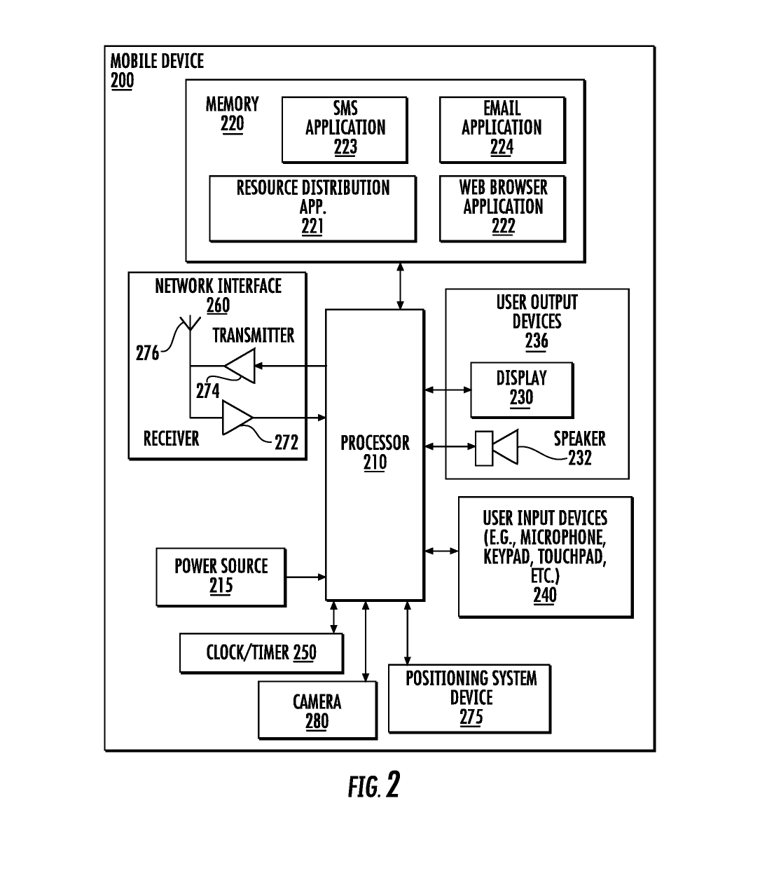

FIG. 2 provides a block diagram illustrating a user's mobile device 200 of FIG. 1 in more detail, in accordance with embodiments of the invention. In one embodiment of the invention, the mobile device 200 is a mobile telephone. However, it should be understood that a mobile telephone and the embodiment of the mobile device 200 shown in FIG. 2 are merely illustrative of one type of mobile device 200 that may benefit from, employ, or otherwise be involved with embodiments of the present invention and, therefore, should not be taken to limit the scope of embodiments of the present invention. Other types of mobile devices 200 may include portable digital assistants (PDAs), pagers, tablets, mobile televisions, gaming devices, laptop computers, cameras, video recorders, audio/video player, radio, GPS devices, or any combination of the aforementioned.

Some embodiments of the mobile device 200 include a processor 210 communicably coupled to such devices as a memory 220, user output devices 236, user input devices 240, and a network interface 260. The mobile device 200 further includes a power source 215, such as a battery, for powering various circuits and other devices that are used to operate the mobile device 200. Embodiments of the mobile device 200 may also include a clock or other timer 250 configured to determine and, in some cases, communicate actual or relative time to the processor 210 or one or more other devices. The mobile device 200 may also include a camera 280 and a positioning system device 275 The processor 210, and other processing devices described herein, generally include circuitry for implementing communication and/or logic functions of the associated device. For example, the processor 210 may include a digital signal processor device, a microprocessor device, and various analog to digital converters, digital to analog converters, and/or other support circuits. Control and signal processing functions of the mobile device 200 are allocated between these devices according to their respective capabilities. The processor 210 thus may also include the functionality to encode and interleave messages and data prior to modulation and transmission. The processor 210 can additionally include an internal data modem. Further, the processor 210 may include functionality to operate one or more software programs, which may be stored in the memory 220. For example, the processor 210 may be capable of operating a connectivity program, such as a web browser application 222. The web browser application 222 may then allow the mobile device 200 to transmit and receive web content, such as, for example, location-based content and/or other web page content, according to a Wireless Application Protocol (WAP), Hypertext Transfer Protocol (HTTP), and/or the like. The memory device 220 may include other applications such as e-mail app 224 and SMS app 223.

The processor 210 is configured to use the network interface 260 to communicate with one or more other devices on the network 150. In this regard, the network interface 260 includes an antenna 276 operatively coupled to a transmitter 274 and a receiver 272 (together a “transceiver”). The processor 210 is configured to provide signals to and receive signals from the transmitter 274 and receiver 272, respectively. The signals may include signaling information in accordance with the air interface standard of the applicable cellular system of the wireless telephone network 152. In this regard, the mobile device 200 may be configured to operate with one or more air interface standards, communication protocols, modulation types, and access types. By way of illustration, the mobile device 200 may be configured to operate in accordance with any of a number of first, second, third, and/or fourth-generation communication protocols and/or the like. For example, the mobile device 200 may be configured to operate in accordance with second-generation (2G) wireless communication protocols IS-136 (time division multiple access (TDMA)), GSM (global system for mobile communication), and/or IS-95 (code division multiple access (CDMA)), or with third-generation (3G) wireless communication protocols, such as Consolidated Mobile Telecommunications System (UMTS), CDMA2000, wideband CDMA (WCDMA) and/or time division-synchronous CDMA (TD-SCDMA), with fourth-generation (4G) wireless communication protocols, with LTE protocols, with 3GPP protocols and/or the like. The mobile device 200 may also be configured to operate in accordance with non-cellular communication mechanisms, such as via a wireless local area network (WLAN) or other communication/data networks.

As described above, the mobile device 200 has a user interface that may be made up of user output devices 236 and/or user input devices 240. The user output devices 236 include a display 230 (e.g., a liquid crystal display or the like) and a speaker 232 or other audio device, which are operatively coupled to the processor 210. The user input devices 240, which allow the mobile device 200 to transmit data, may include any of a number of devices allowing the mobile device 200 to transmit data, such as a keypad, keyboard, touch-screen, touchpad, microphone, mouse, joystick, other pointer device, button, soft key, and/or other input device(s).

The memory 220 is operatively coupled to the processor 210. As used herein, “memory” or “memory device” includes any computer readable medium (as defined herein below) configured to store data, code, or other information. The memory 220 may include volatile memory, such as volatile Random Access Memory (RAM) including a cache area for the temporary storage of data. The memory 220 may also include non-volatile memory, which can be embedded and/or may be removable. The non-volatile memory can additionally or alternatively include an electrically erasable programmable read-only memory (EEPROM), flash memory or the like.

The memory 220 can store any of a number of applications which comprise computer-executable instructions/code executed by the processor 210 to implement the functions of the mobile device 200 and/or one or more of the process/method steps described herein. The memory 220 also includes a resource distribution application 221 that may be used to allow communication with a third party system such as the financial institution system 400 and/or the smart devices to implement the system of the invention. The use of the resource distribution application 221 may facilitate access to the system of the invention by providing log-in systems including user authentication systems, account information, system controls or the like. The resource distribution application 221 also allows communication to the smart devices and to the financial institution to allow the user to set up and/or control the system of the invention.

These applications also typically provide a graphical user interface (GUI) on the display 230 that allows the user 110 to communicate with the mobile device 200, the financial institution system 400 and/or other devices or systems. The memory 220 can also store any of a number of pieces of information, and data, used by the mobile device 200 and the applications and devices that make up the mobile device 200 or are in communication with the mobile device 200 to implement the functions of the mobile device 200 and/or the other systems described herein. For example, the memory 220 may include such data as user authentication information.

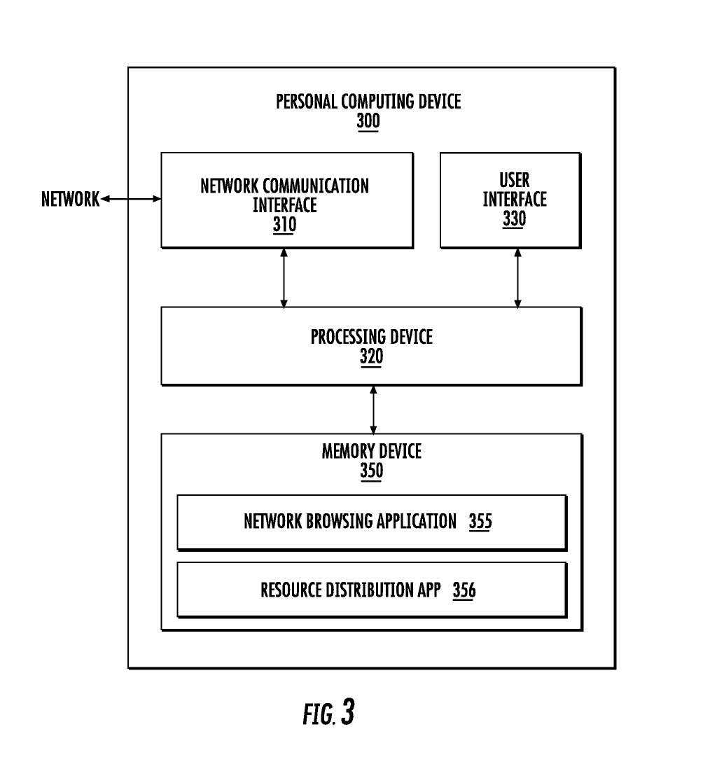

Referring now to FIG. 3, the personal computing device 300 also includes various features, such as a network communication interface 310, a processing device 320, a user interface 330, and a memory device 350. The network communication interface 310 includes a device that allows the personal computing device 300 to communicate over the network 150 (shown in FIG. 1). In one embodiment of the invention, a network browsing application 355 provides for a user to establish network communication with a financial institution system 400.

As used herein, a “processor” or “processing device,” such as the processing device 320, generally refers to a device or combination of devices having circuitry used for implementing the communication and/or logic functions of a particular system. For example, a processing device 320 may include a digital signal processor device, a microprocessor device, and various analog-to-digital converters, digital-to-analog converters, and other support circuits and/or combinations of the foregoing. Control and signal processing functions of the system are allocated between these processing devices according to their respective capabilities. The processing device 320 may further include functionality to operate one or more software programs based on computer-executable program code thereof, which may be stored in memory device 350. As the phrase is used herein, a processor or processing device may be “configured to” perform a certain function in a variety of ways, including, for example, by having one or more general-purpose circuits perform the function by executing particular computer-executable program code embodied in computer-readable medium, and/or by having one or more application-specific circuits perform the function.

As used herein, a “user interface” generally includes a plurality of interface devices and/or software that allow a customer to input commands and data to direct the processing device to execute instructions. For example, the user interface 330 presented in FIG. 3 may include a graphical user interface (GUI) or an interface to input computer-executable instructions that direct the processing device 320 to carry out specific functions. The user interface 330 employs certain input and output devices as previously described with reference to FIGS. 1 and 2. These input and output devices may include a display, mouse, keyboard, button, touchpad, touch screen, microphone, speaker, LED, light, joystick, switch, buzzer, bell, and/or other user input/output device for communicating with one or more users.

As used herein, a “memory” or “memory device” generally refers to a device or combination of devices that store one or more forms of computer-readable media for storing data and/or computer-executable program code/instructions. Computer-readable media is defined in greater detail below. For example, in one embodiment, the memory device 350 includes any computer memory that provides an actual or virtual space to temporarily or permanently store data and/or commands provided to the processing device 320 when it carries out its functions described herein. The memory device 350 may include such applications as a conventional web browser application 355 and/or a resource distribution application 356. The resource distribution application 356 may be used to allow communication with the third party entity such as financial institution system 400 to provide access to the financial institution providing log-in systems including user authentication systems, account information or the like as previously described with respect to FIG. 2. The resource distribution application 356 also allows communication to the smart devices and to the third party financial institution system 400 to allow the user to set up and/or control the system of the invention.

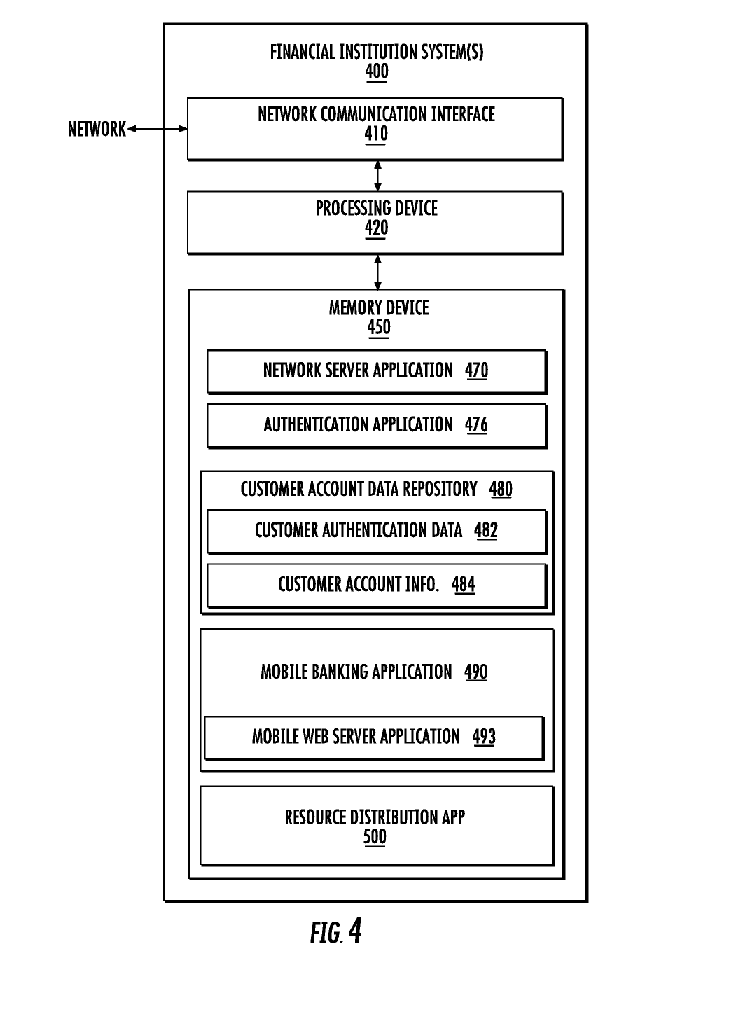

FIG. 4 provides a block diagram illustrating the third party financial institution system 400, in greater detail, in accordance with embodiments of the invention. As illustrated in FIG. 4, in one embodiment of the invention, the financial institution system 400 includes one or more processing devices 420 operatively coupled to a network communication interface 410 and a memory device 450. In certain embodiments, the financial institution system 400 is operated by an entity, such as a financial institution.

It should be understood that the memory device 450 may include one or more databases or other data structures/repositories. The memory device 450 also includes computer-executable program code that instructs the processing device 420 to operate the network communication interface 410 to perform certain communication functions of the financial institution system 400 described herein. For example, in one embodiment of the financial institution system 400, the memory device 450 includes, but is not limited to, a network server application 470, an authentication application 460, a customer account data repository 480 which includes customer authentication data 480 and customer account information 484, a mobile banking application 490 comprising a mobile web server application 493, and other computer-executable instructions or other data. The computer-executable program code of the network server application 470, the authentication application 460, or the mobile banking application 490 may instruct the processing device 420 to perform certain logic, data-processing, and data-storing functions of the financial institution system(s) 400 described herein, as well as communication functions of the financial institution system(s) 400. The mobile banking application 490 communicates with the user computing devices 120 to facilitate communication between the user and the financial institution.

In one embodiment, the customer account data repository 480 includes customer authentication data 482 and customer account information 484. The network server application 470, the authentication application 460, and the mobile banking application 490 are configured to invoke or use the customer account information 484, the customer authentication data 482 when authenticating a user to the financial institution system(s) 400.

The financial institution system 400 further includes a resource distribution application 500 that communicates with the smart devices 600 and may communicate with the user's computing devices 120. The resource distribution application 500 functions to distribute a user's resources as informed by the resource distribution application 656 of the smart device 600. In some embodiments, the resource distribution application is a payment application that provides a payment rail to third party entities associated with the smart devices as will be described and allows the user to establish and control the payment rail.

As used herein, a “communication interface” generally includes a modem, server, transceiver, and/or other device for communicating with other devices on a network. The network communication interface 410 is a communication interface having one or more communication devices configured to communicate with one or more other devices on the network 150, such as the mobile device 200, the personal computing device 300, and the smart devices 600. The processing device 420 is configured to use the network communication interface 410 to transmit and/or receive data and/or commands to and/or from the other devices connected to the network 150.

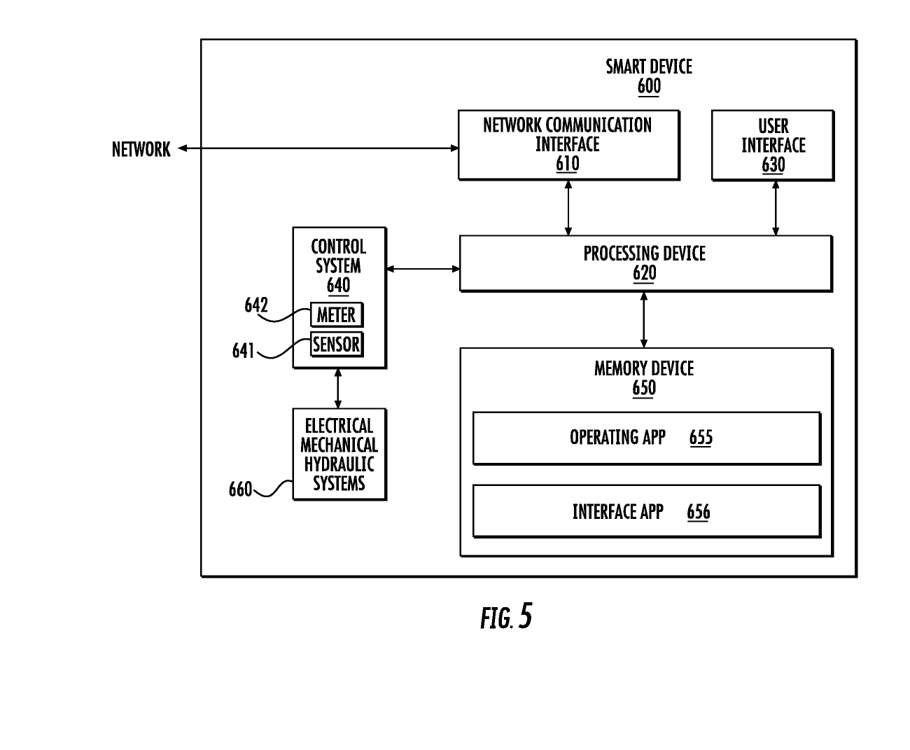

FIG. 5 provides a block diagram illustrating smart device 600, in accordance with embodiments of the invention. A “smart device” as used herein means a device, apparatus and/or system that is capable of communicating with and transmitting information or data to and/or receiving information or data from other devices, systems or apparatuses including over network 150. FIG. 5 illustrates an exemplary embodiment of a smart device. The smart device 600 may be for example, but not limited to, a machine such as an automobile, tractor trailer, airplane, manufacturing device, warehouse device, material handling system, conveyor system, robotics or the like; appliances such as refrigerators, washer/dryers, dish washers, or the like; home entertainment devices or systems such as set top boxes, gaming systems, internet televisions, or the like; home or building systems such as home security systems, utility systems such as electrical, water, plumbing systems and apparatuses such as electric meters, water meters, hot water heaters, gas meters or the like; and personal devices such as wearable devices such as internet capable fitness devices, watches, glasses or the like. The list of smart devices provided herein is not exhaustive such that the smart device 600 may be any device that includes a communication interface or module, software and/or hardware that allow the device to communicate data and/or information related to the device with other devices and/or systems over network 150.

As illustrated in FIG. 5, one exemplary embodiment of a smart device 600 may generally include, but is not limited to, a network communication interface 610, a processing device 620, and a memory device 650 such as described herein. The processing device 620 is operatively coupled to the network communication interface 610 and the memory device 650. The smart device may also have a control system 640 for controlling the physical operation of the device. The control system may comprise one or more sensors 641 for detecting operating conditions of the various mechanical and electrical systems 660 that comprise the smart device or of the environment in which the smart device is used. The sensors 641 may communicate with the processing device to provide feedback to the operating systems of the device. The control system may also comprise metering devices 642 for measuring performance characteristics of the smart device. The control system 640 may also comprise controllers such as programmable logic controllers (PLC), proportional integral derivative controllers (PID) or other machine controllers. The smart device may also comprise various electrical, mechanical, hydraulic or other systems 660 that perform various functions of the smart device. These systems may comprise, for example, electrical circuits, motors, compressors, or any system that enables functioning of the smart device.

In one embodiment, applications having computer-executable program code that instruct the processing device 620 to operate the various systems of the smart device including network communication interface 610 to perform certain communication functions and to perform certain logic, data processing, and data storing functions of the application as described herein are stored in memory device 650. The applications may include a smart device operating application 655 that controls the various systems 640, 660 and functions of the smart device to control operation of the smart device during use. The applications may also comprise a resource distribution application 656 that communicates with the third party system and/or associated host systems as will be described. The various applications of the smart device may communicate with one another such that information available to the operating application 655 is also available to the resource distribution application 656. The resource distribution application 656 may also be provided in a separate module or chip set such as a application specific integrated circuit.

The network communication interface 610 is a communication interface having one or more communication devices configured to communicate with one or more other devices on the network 150. The processing device 620 is configured to use the network communication interface 610 to receive information from and/or provide information and commands to other devices and systems via the network 150. The network communication interface 610 may be over a wireless connection or a wired connection such as described above. The smart device may also comprise a user interface 630. The user interface allows inbound and/or outbound communication with the smart device and may take a wide variety of forms depending on the type of smart device. The user interface may comprise interface devices as previously described with respect to FIGS. 3 and 4 and/or may comprise other user interface devices such as appliance input devices such as push buttons, entertainment input devices such as remote controls, vehicle input devices such as found on an automobiles infotainment systems or the like. In some embodiments the input device may be controlled by the host entity such that the smart device is secure. For example, with a utility meter the user interface 630 may be controlled by the utility. In some embodiments, such as utility meters the input device may be a specialized plug-in device or it may be remote from the smart device and may access the smart device over a public or private network.

In one embodiment the resource distribution application 656, processing device 620 and the memory device 650 are operable to effect a transaction with a third party financial institution system 400. The smart device may be programmed with the resource distribution application 656 in memory 650 or provided as a chip set or module during manufacture of the smart device 600 to interact and complete a data exchange with a third party system such as financial institution system 400 that is not related to the host entity of the smart device 600. In other words the smart device 600 is programmed with the resource distribution application 656 to communicate with a third party system (e.g. the financial institution system 400) where the third party system is operated and managed by an entity that is independent of the host system (e.g. the operator of/provider to the smart device). In some embodiments, the smart device may not be preloaded with the resource distribution application 656; however, the smart device is configured to allow a third party program to be downloaded to the smart device and to be executed on the processing device 620 of the smart device 600. In either case the resource distribution application 656 is embedded with the smart device such that the resource distribution program is provided with and runs on the processing device 620 of the smart device 600.

The term “host entity” as used herein means the entity that operates the smart device for its primary function or that interacts with the smart device for its primary function. For example, a cable service provider is the host entity for a user's cable box and associated cable service. Likewise, a utility, such as a power company, is the host entity for a user's electric meter and associated electric service. Moreover, for smart machines that require renewable products or accessories the host entity is the entity that provides the renewables used by the smart device. The “host entity” may comprise a “host system” or “host device” that communicates with other devices and systems. As used herein “third party entity” refers to an entity that is not the host entity that utilizes the embedded resource distribution application 656. The “third party entity” may comprise a “third party system” or “third party device” that communicates with other devices and systems. For example, the third party entity may be a financial institution that provides a payment rail to the host entity for services or products associated with the smart device. Specific example embodiments of the operation of the system will be provided. In one example embodiment the third party system is the financial institution system 400 of a financial institution and the resource distribution between the smart device, the host entity and the financial institution is a financial transaction that may comprise a payment from the user's financial institution to the host entity.

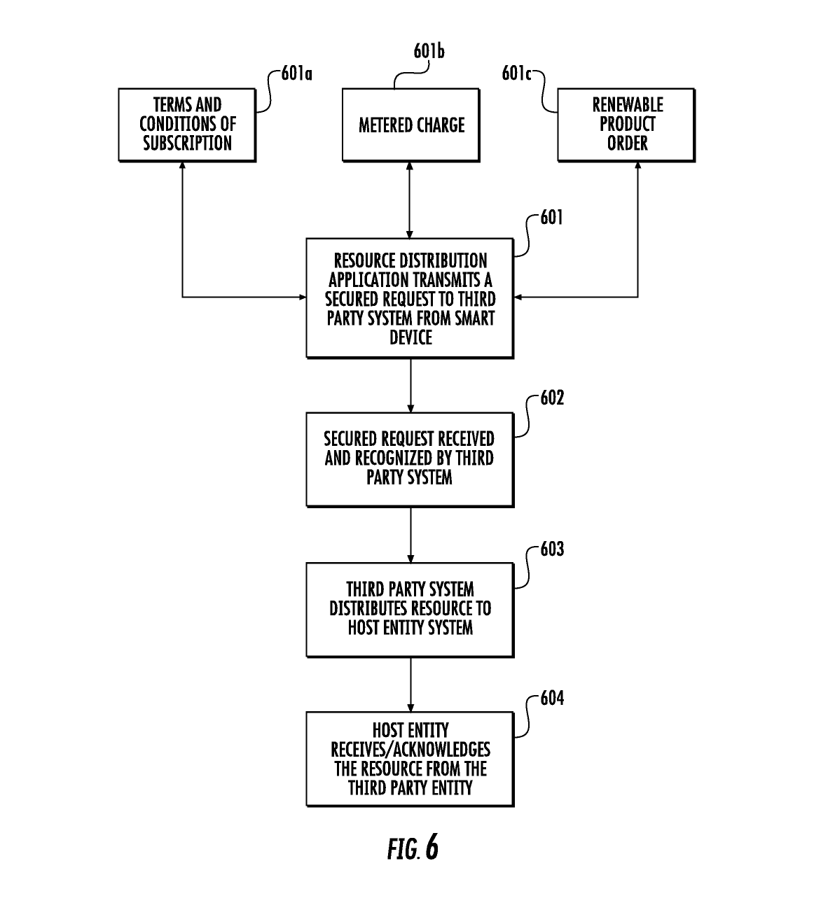

Referring to FIGS. 1 and 6, an embodiment of one process and system will be described. In this embodiment the smart device 600a comprises a device that requires a predetermined payment by the user to enable operation of the device and/or provision of a service over that device. Example embodiments of such devices and services are systems that require the user to enter into a contract or subscription with a service provider where the terms of the contract or subscription require agreed upon payments in order for the user to obtain the contracted for service. Such systems are referred to herein as “subscription” systems, services and devices. Common examples of such subscription devices include, but are not limited to, cellular phones, tablets, laptop computers, personal computers, set top boxes, wearable devices, land line phones, receivers such as cable boxes, satellite receivers, internet ready televisions, or the like. Such devices may provide cellular phone service, entertainment services such as cable, satellite, internet that provide television, movie, news, music or other content to a user. Other examples of such devices and services are automobiles with wireless audio connectivity, and security systems with control boxes having wireless or hard wired connectivity. Still other examples of such devices and services are connected gaming systems and consoles. In these and other similar systems the operation of the system, the provision of devices and/or services associated with system and the manufacture, sale, lease, installation or other provision of equipment is controlled and/or provided by one or more host entities 701. For example, the host entity may comprise, but is not limited to, cable television provider, a phone service company, a satellite radio/television provider, a gaming company, an ISP, an automobile manufacturer, a security company, a content provider or other entity. In some embodiments the entity that provides the smart device and the entity that provides the associated service may be different entities where one or both of the entities may be a host entity. For example, a television manufacturer may provide an internet capable television but the service may be provided by a separate content provider such as an internet streaming service. In other embodiments the host entity provides both the smart device and the associated service. For example, with the example of cable television the host entity may comprise the cable system operator that manufactures or contracts for the manufacture of equipment, installs the infrastructure, sells or leases the equipment to the end user and arranges the provision of content to the user. The user may pay for the subscribed service either in regular installments or on a per use basis. For example, the user may pay a regular monthly payment and/or an on-demand per use rental fee. The terms and conditions of the payments are maintained in the memory device 650 of the smart device and are accessible to the resource distribution application 656. Information used by the resource distribution application 656 to generate the secured request is referred to herein as host information and may comprise any information used by the resource distribution application 656 to generate and transmit the secured request and to initiate the resource distribution from the third party system.

In one embodiment of the invention, the smart machine 600a is programmed with a resource distribution application 656 that provides for the payment of the required subscription fees such that the payment of the required fees may be initiated by the smart device 600a. The smart device is in machine to machine communication with the third party financial institution system 400 to effectuate payment to the host entity system 700 of the host entity 701. In one embodiment the resource distribution application 656 transmits a secured request such as a token to the financial institution system 400 over network 150 via network communication device 610 (block 601). The secured request is informed by and transmitted in accordance with the terms and conditions of the subscription (host information) (block 601a). The secured request comprises resource distribution information where resource distribution information is the information contained in the secured request that is used by the third party system to distribute the resource. In a system that uses a token or other secured request the resource distribution information may have no intrinsic value. For example, a secured request may be sent monthly requesting payment of the user's monthly subscription fee. Tokenization security systems are known where a token having no intrinsic value is substituted for sensitive data such that the authorization does not involve the transmission of sensitive data such that security is enhanced and security risks from data breaches are reduced. In the present invention the token is substituted for user account information such that the token generated by the smart device is translated and attributed to a user's financial identity at the financial institution system 400. The token is translated by the financial institution to identify the user's financial identity and the source of the token. Through rules set up between the user and the financial institution, the financial institution makes the payment to the host entity along the payment rail established by the user. The user may establish the rules via a portal such as an on-line banking system using computing devices 120 or otherwise. The smart device 600a and host entity 701 do not have user account information which is securely maintained by the third party financial institution system 400. As a result the security of the user's financial information is maintained by a single entity such that security over the user's financial information may be controlled and enhanced. The smart device generates the secured request based on the host information using the resource distribution application 656 embedded in the smart device and transmits the secured request using network communication interface 610 to the third party financial institution system 400 over network 150. Because the resource distribution application 656 is embedded in the smart device, the resource distribution application 656 has access to any information or data stored in or obtained by the smart device. The secured request is received by the third party system and the resource distribution information in the secured request is recognized by the third party system 400 and informs the third party system of the designated resource distribution to the host entity system 700 (block 602). Where the resource distribution application 656 is a payment application the secured request informs the financial institution system 400 to pay the required payment on behalf of the user to the appropriate host entity system 700 of host entity 701 that operates the subscription smart device 600a or that provides the subscription service to the smart device. The rules established between the user and the financial institution allow the user to select the desired payment rail. Moreover, a single smart device may use different payment rails for different activities of the smart device. Upon receiving the secured request, the third party system 400 distributes resources to the host entity system 700 in accordance with the resource distribution application 500. Where the resource distribution application 656 is a payment application the third party financial institution system 400, using resource distribution application 500, generates a payment to the host entity system 700 on a payment rail as directed by the financial institution's agreement with the user (block 603). For example, the payment rail may be made as a debit on a debit card account, as a charge to a credit card account, as a withdrawl from a user designated account or using another financial instrument of the financial institution. A single smart device may use different payment rails for different activities as set up in the payment rules established between the user and the financial institution. For example, for one activity of the smart device the payment rail may be designated by the user as a charge to a first credit card and for a second activity of the same smart device the payment rail may be designated by the user as a debit to a debit card account. The secured request may identify the type of activity to the financial institution in addition to identifying the smart device. The payment rail may also be established by the user, such as via user device 120, based on the type of vendor, the dollar amount of purchase or other criteria. The payment or other distributed resource is received by the host entity system 700 and the host entity system may transmit an acknowledgement message to the third party system 400 (block 604). In some embodiments a message may be transmitted to the smart device to indicate that the request has been completed so that the smart device does not repeat the request to the financial institution. The message may be transmitted from either or both of the financial institution and the host entity to the smart device. The financial institution may also record all payments in the user's financial transaction history with the financial institution such that the transaction history is available to the user such as via a user portal such as an on-line banking application.

In the example of a cable provider, the user 110 may have a monthly payment due to the cable provider (the host institution 701) (block 601a). A secured request such as a token is generated by the resource distribution application 656 embedded with the cable box (the smart device 600a) every month (block 601). The secured request is received by the financial institution system 400 (the third party system) (block 602) and payment is made from the financial institution system 400 to the cable provider system 700 (the host entity system) (block 603). The payment is received by the cable provider 701 and the cable provider system 700 may transmit an acknowledgement of the payment to the financial institution system 400 (block 604). Moreover, if the user 110 purchases an additional on-demand service such as an on-demand movie, a secured request is generated by the resource distribution application 656 embedded with the cable box 700 for the payment associated with that activity and payment is made from the financial institution system 400 to the cable provider system 701 as previously described. As previously described, the payment may be made on the payment rail or multiple payment rails agreed upon by the user and the financial institution.

Use of a secured request such as a token or other encoded request enhances security for the user because the user's financial information is maintained at the user's financial institution and is not provided to every host entity with which the user has a relationship. The system also increases convenience of the user's payments because the smart device automatically communicates the token or other secured request in response to a predetermined action or activity programmed in the resource distribution application 656. Because the resource distribution application 656 is embedded with the smart device 600, the operating system of the smart device can communicate with the resource distribution application such that the resource distribution application may transmit the appropriate secured request based on operation of the smart device.

The terms and conditions of the resource distribution may be agreed to by the user and the third party entity. For example where the resource distribution application 656 is a payment application the terms and conditions of the payment may be established. Upon taking control of, installing or otherwise accessing the smart device 600, the user may register the smart device with the third party system 400 such that the third party system recognizes a secured request from that smart device as belonging to that user (block 701). The user may access the user's account via an on-line application through a user device 120 to register the smart device with the third party entity. In the case of a financial institution the user may register the smart device through the on-line banking application. The user may also register the smart device with the third party system other than using an on-line application 490. In some embodiments the smart device 600 may register itself with the third party entity based on information provided to the smart device by the user during start-up of the smart device (block 702). In the case of a financial transaction as described above, the user may access the user's account via the on-line banking application through a user device 120 to associate the smart device with a user specified payment rail such that payment is effected by the financial institution 400 to the host entity system 700 along the designated payment rail (block 703). The user may also set up the payment terms and conditions with the financial institution 400 such as establishing payment limits and/or other controls (block 704). For example, the user may designate a maximum amount that may be paid per transaction, a maximum aggregate amount, a limit on the frequency of payments or the like. For other types of resource distributions other limits or controls may be set. In some embodiments the limits or controls put on the smart device may originate with the third party system 400 such that the payment application may be controlled at least in part by the third party. For example, a financial institution system 400 may establish a credit limit.

Referring again to FIGS. 1 and 6, the smart device 600b may comprise a smart device that meters usage of a product or service where payment by the user is based on usage levels. Example embodiments of such devices and services are systems such as utilities including, but not limited to, water utilities, electrical utilities, gas utilities that utilize meters to determine usage. With the system of the invention, the smart device 600b comprises a meter 642 or other sensor 641 that generates a signal when a predetermined condition is met. The signal is received by the processor and is used to initiate the generation of he secured request. The resource distribution application 656 provides for payment of the required charges by the smart device 600b (e.g. the utility meter) based on the user's usage. The payment is made by machine to machine communication between the financial institution system 400, the smart device and the host entity system. The resource distribution application 656 obtains either the usage amount or a dollar amount based on the usage amount either from the operating application 655 or by direct communication of meter 642 (block 601b). As previously explained, in one embodiment the resource distribution application 656 comprises a payment application that transmits a secured request such as a token to the financial institution system 400. The secured request is received by the financial institution and is recognized as an instruction to pay the required payment on behalf of the user to the host system, e.g. the utility that operates the smart device. The smart device 600b generates a secured request based on the financial institution application embedded in the smart device and transmits the secured request to the financial institution over network 150 (block 601). Upon receiving and recognizing the secured request (block 602) the financial institution 400 may generate a payment to the host entity system 900 based upon the terms with the user (block 603). The payment is received by the host entity system 900 and the host entity system may send an acknowledgement message to the financial institution system 400 (block 604).

In the example of a utility, the user may have a monthly payment due to the utility (the host institution 901) based on the usage detected by the utility meter (the smart device 600b). A secured request such as a token is generated by the resource distribution application 656 embedded with the utility meter (the smart device 600b) based on the usage detected by the meter and is transmitted to the third party financial institution system 400 over network 150. The token is received by the third party system 400 (e.g. the user's financial institution) and payment is made from the third party financial institution system 400 to the utility system 900 over network 150 upon receipt of the token. The payment may be made in any manner agreed upon by the user and the financial institution using any appropriate payment rail. The utility system may send an acknowledgment message to the financial institution system upon receipt of payment.

Referring again to FIGS. 1 and 6, the smart device 600c may comprise a device that is used with a renewable product. Example embodiments of such devices and systems include water filtration systems that require new filters; water softener systems that require salt; appliances such as washing machines, dryers, dishwashers, and the like that require detergent, bleach, fabric softeners and the like; HVAC systems that require air filters; automobiles, boats, trucks and other vehicles that require oil, filters, light bulbs or the like. Other examples of such systems are smart home/building systems where systems such as HVAC, security systems, utilities, lighting, or the like may include interconnected smart devices that may include one or more of the devices discussed above. In a smart system the renewable product may include one or more of the renewable products discussed above in addition to other renewable products such as light bulbs, trash can liners, food, batteries or any renewable product. The smart device 600c may also include devices such as a refrigerator that monitors food usage, a trash can that monitors trash bag liner usage, a home electrical smart grid, smart lamps, or light fixtures that monitor light bulb operation or other devices and systems. The embodiments of systems and devices described herein are by way of example and a wide variety of systems and devices may be used to implement the invention in addition to those specifically described.

Typically the smart device 600c may include one or more sensors that detect or determine a status of the renewable product or the smart device may include program logic in operating application 655 that estimates the status of the renewable product. The sensor generates a signal when a predetermined condition is met. The signal is received by the processor and is used to initiate the generation of he secured request. The smart device 600c may include a sensor 641 that directly monitors the status of the renewable product. For example, in a water filtration system the sensor 641 may monitor the water flow rate through the water filter; in a HVAC system the sensor 641 may monitor the air flow rate through the air filter; in a lighting system the sensor 641 may monitor the current drawn by a light bulb in a fixture; in a refrigerator the sensor 641 may monitor the weight of a gallon of milk. The embodiments of systems and devices described herein are by way of example only and are not intended to be limiting and a wide variety of systems and devices may be used to implement the invention in addition to those specifically described. In other embodiments, the status of the renewable product may be determined by program logic rather than the direct monitoring of the renewable product. For example, the status of the renewable product may be based on time intervals, usage rates, or the like. For example, in an HVAC system or water filtration system the replacement of a filter may be determined by a calculation of hours of usage rather than flow rate through the filter; in a “smart refrigerator” food may be ordered based on time intervals (e.g. a carton of milk ordered every week) rather than on weight of the product. The host entity 1001 may comprise any entity comprising a host entity system 1002 from which the smart device 600c can order the renewable product over network 150. For example the host entity may comprise an on-line retailer, an e-commerce site, a dedicated web site, a host entity web site or the like.

In systems that use a renewable product such as those described above, the smart device 600c may order on-line replacement products when replacement of the renewable product is determined by the smart device 600c. The order may be placed by the smart device 600c to a host entity system 1002 of host entity 1001. The host entity may be a dedicated source of the renewable product, such as a water filtration system manufacturer/operator that provides replacement water filters, or the host entity may be an on-line retailer that is unrelated to the smart machine other than acting as the source of the renewable product. In either event the smart device 600c is in machine to machine communication with the host entity system 1002 of the host entity selling or providing the renewable product over network 150. The smart device 600c orders the appropriate renewable based using the resource distribution application 656 embedded in the smart device. The order may be based on the output of a sensor or program logic as previously described (block 601c). When the smart device 600c determines that a renewable is to be ordered, the resource distribution application 656 is initiated to send a secured request such as a token to the financial institution system 400. The secured request is received by the financial institution 400 (e.g. the user's bank) and the order for the renewable is made and payment is made from the financial institution 400 to the host entity system 1002 over network 150 upon receipt of the token. In some embodiments the smart device 600c may place the order for the renewable product and the third party financial institution system 400 may make the payment in a separate communication with the host entity system. In other embodiments the order and payment may both be made in a communication from the third party financial institution system 400 to the host entity where the resource distribution information comprises information related to the ordering of the renewable product such as identification of product, identification of host entity, identification of delivery address. In either case the user financial information is maintained by the third party financial institution. The payment may be made in any manner agreed upon by the user 110 and the financial institution 400 as previously described. The renewable product is delivered by the host entity 1001 to the smart device 600c in the manner agreed upon during ordering of the renewable product. In addition to purchasing renewable products for the smart device the smart device may order replacement parts, repair service or even an entirely new smart device upon the detection of a failure condition at the smart device. Payment is effected by the smart device as previously explained.

In addition to the forward communications from the smart device to the third party system, the system may allow inbound communication to the smart device such that the user and/or third party system may direct the resource distribution options. For example, the user may set limits in the smart device on the amount payable by a financial institution based on receiving a secure request from the smart device. The limit may be based on dollar amount per transaction, total dollar amount, frequency of purchase, or the like. The user may directly communicate with the smart device over network 150 using computing device 120 or the user instructions may be communicated to the third party system 400 from the user such as by computing device 120 over network 150 and the third party system 400 may communicate with the smart device over network 150. In some embodiments the limits or controls put on the smart device may originate with the third party system 400 such that the resource distribution may be controlled at least in part by the third party. For example, a financial institution system may establish a credit limit. In some embodiments the secured request may be sent by the smart device upon the receipt of an inbound communication. For example, the smart device may be capable of receiving an inbound message where the smart device is configured to undertake an activity such as ordering a product upon receipt of the inbound message. For example, the smart device may comprise an automobile infotainment system or a wearable device that receives a signal from other smart devices as the vehicle or wearable device moves through the smart environment. Upon receipt of a predetermined signal the smart device orders a product or service and payment for the product or service occurs as previously described. For example, an automobile's smart system may authorize payment of a toll when the automobile passes through a smart toll booth or the automobile's smart system may order a cup of coffee when the automobile passes the smart ordering system of a coffee shop. In these and other embodiments the ordering of the product and the initiation of payment occurs when the smart device receives an inbound signal from an authorized and recognized smart device.

As will be appreciated by one of skill in the art, the present invention may be embodied as a method (including, for example, a computer-implemented process, a business process, and/or any other process), apparatus (including, for example, a system, machine, device, computer program product, and/or the like), or a combination of the foregoing. Accordingly, embodiments of the present invention may take the form of an entirely hardware embodiment, an entirely software embodiment (including firmware, resident software, micro-code, etc.), or an embodiment combining software and hardware aspects that may generally be referred to herein as a “system.” Furthermore, embodiments of the present invention may take the form of a computer program product on a computer-readable medium having computer-executable program code embodied in the medium. Any suitable transitory or non-transitory computer readable medium may be utilized. The computer readable medium may be, for example but not limited to, an electronic, magnetic, optical, electromagnetic, infrared, or semiconductor system, apparatus, or device. More specific examples of the computer readable medium include, but are not limited to, the following: an electrical connection having one or more wires; a tangible storage medium such as a portable computer diskette, a hard disk, a random access memory (RAM), a read-only memory (ROM), an erasable programmable read-only memory (EPROM or Flash memory), a compact disc read-only memory (CD-ROM), or other optical or magnetic storage device.

In the context of this document, a computer readable medium may be any medium that can contain, store, communicate, or transport the program for use by or in connection with the instruction execution system, apparatus, or device. The computer usable program code may be transmitted using any appropriate medium, including but not limited to the Internet, wireline, optical fiber cable, radio frequency (RF) signals, or other mediums.

Computer-executable program code for carrying out operations of embodiments of the present invention may be written in an object oriented, scripted or unscripted programming language such as Java, Perl, Smalltalk, C++, or the like. However, the computer program code for carrying out operations of embodiments of the present invention may also be written in conventional procedural programming languages, such as the “C” programming language or similar programming languages.

Embodiments of the present invention are described above with reference to flowchart illustrations and/or block diagrams of methods, apparatus (systems), and computer program products. It will be understood that each block of the flowchart illustrations and/or block diagrams, and/or combinations of blocks in the flowchart illustrations and/or block diagrams, can be implemented by computer-executable program code portions. These computer-executable program code portions may be provided to a processor of a general purpose computer, special purpose computer, or other programmable data processing apparatus to produce a particular machine, such that the code portions, which execute via the processor of the computer or other programmable data processing apparatus, create mechanisms for implementing the functions/acts specified in the flowchart and/or block diagram block or blocks.

These computer-executable program code portions may also be stored in a computer-readable memory that can direct a computer or other programmable data processing apparatus to function in a particular manner, such that the code portions stored in the computer readable memory produce an article of manufacture including instruction mechanisms which implement the function/act specified in the flowchart and/or block diagram block(s)

The computer-executable program code may also be loaded onto a computer or other programmable data processing apparatus to cause a series of operational steps to be performed on the computer or other programmable apparatus to produce a computer-implemented process such that the code portions which execute on the computer or other programmable apparatus provide steps for implementing the functions/acts specified in the flowchart and/or block diagram block(s).

As the phrase is used herein, a processor may be “configured to” perform a certain function in a variety of ways, including, for example, by having one or more general-purpose circuits perform the function by executing particular computer-executable program code embodied in computer-readable medium, and/or by having one or more application-specific circuits perform the function.

Embodiments of the present invention are described above with reference to flowcharts and/or block diagrams. It will be understood that steps of the processes described herein may be performed in orders different than those illustrated in the flowcharts. In other words, the processes represented by the blocks of a flowchart may, in some embodiments, be in performed in an order other that the order illustrated, may be combined or divided, or may be performed simultaneously. It will also be understood that the blocks of the block diagrams illustrated, in some embodiments, merely conceptual delineations between systems and one or more of the systems illustrated by a block in the block diagrams may be combined or share hardware and/or software with another one or more of the systems illustrated by a block in the block diagrams. Likewise, a device, system, apparatus, and/or the like may be made up of one or more devices, systems, apparatuses, and/or the like. For example, where a processor is illustrated or described herein, the processor may be made up of a plurality of microprocessors or other processing devices which may or may not be coupled to one another. Likewise, where a memory is illustrated or described herein, the memory may be made up of a plurality of memory devices which may or may not be coupled to one another.

### INCORPORATION BY REFERENCE

To supplement the present disclosure, this application further incorporates entirely by reference the following commonly assigned patent applications:

| | U.S. patent application | | |
|---|---|---|---|
| Docket Number | Ser. No. | Title | Filed On |
| 7085US1.014033.2722 | To be assigned | ENHANCING AUTHENTICATION | Concurrently |
| | | AND SOURCE OF PROOF | herewith |
| | | THROUGH A DYNAMICALLY | |
| | | UPDATABLE BIOMETRICS | |
| | | DATABASE | |
| 7086US1.014033.2723 | To be assigned | RESOURCE TAG GENERATION | Concurrently |
| | | AND DEPLOYMENT FOR | herewith |
| | | RESOURCE VALUATION AND | |
| | | DISTRIBUTION | |
| 7089US1.014033.2724 | To be assigned | SYSTEM FOR REAL-TIME | Concurrently |
| | | RELEASE OF ALLOCATED | herewith |
| | | RESOURCES BASED ON DEVICE | |
| | | STAGE | |
| 7090US1.014033.2725 | To be assigned | SECURITY IMPLEMENTATION | Concurrently |
| | | FOR RESOURCE DISTRIBUTION | herewith |
| 7097US1.014033.2726 | To be assigned | SECURITY IMPLEMENTATION | Concurrently |
| | | FOR USER RESOURCE | herewith |
| | | DISTRIBUTION WITH | |
| | | PERIPHERAL DEVICE | |
| 7098US1.014033.2727 | To be assigned | INTELLIGENT RESOURCE | Concurrently |
| | | PROCUREMENT SYSTEM | herewith |
| | | BASED ON PHYSICAL | |
| | | PROXIMITY TO RELATED | |
| | | RESOURCES | |
| 7082US1.014033.2728 | To be assigned | SYSTEM FOR MACHINE- | Concurrently |
| | | INITIATED RESOURCE | herewith |
| | | GENERATION AND | |
| | | CUSTOMIZATION | |
| 7084US1.014033.2730 | To be assigned | SYSTEM FOR ADAPTATION OF | Concurrently |
| | | MULTIPLE DIGITAL | herewith |
| | | SIGNATURES IN A | |
| | | DISTRIBUTED NETWORK | |

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

1. A smart device comprising:
a network communication interface;
a memory device storing a smart device operating application and a third party application;
a processing device operatively coupled to the memory device, wherein the processing device is configured to execute computer-readable program code to:
communicate host information from the smart device to a host entity system; and
communicate resource distribution information from the smart device to a third party system where the third party system is different than the host entity system, the resource distribution information usable by the third party system to securely distribute a resource from the third party system to the host entity system.

2. The system of claim 1, wherein the host information comprises at least one of a usage level and an identification of a renewable product.

3. The system of claim 1, wherein the resource distribution information comprises a secured request.

4. The system of claim 3, wherein the secured request comprises a request for payment to the host entity system.

5. The system of claim 4, wherein the secured request comprises a token.

6. The system of claim 3, wherein the smart device comprises a sensor for generating a signal used to initiate the secured request.

7. The system of claim 3, wherein the computer-readable program code comprises logic used to initiate the secured request.

8. The system of claim 1, wherein the host entity system comprises a financial institution system.

9. A third party system comprising:
a network communication interface;
a memory device storing a third party application;
a processing device operatively coupled to the memory device, wherein the processing device is configured to execute computer-readable program code to:
receive resource distribution information from a smart device associated with a host entity system where the resource distribution information is usable to distribute a resource to the host entity system; and
distribute the resource to the host entity system based on the resource distribution information.

10. The system of claim 9, wherein the resource distribution information comprises a secured request.

11. The system of claim 10, wherein the secured request comprises a request for payment to the host entity system.

12. The system of claim 10, wherein the secured request comprises a token.

13. The system of claim 9, wherein the host entity system comprises a financial institution system.

14. The system of claim 9, wherein the distribution comprises a payment from the third party system to the host system.

15. The system of claim 14, wherein an acknowledgement message is received from the host system acknowledging the payment.

16. The system of claim 9, wherein the payment is related to at least one of the purchase of a renewable product, a subscription service and a metered charge.

17. A method for communicating from a smart device, the method comprising:
communicating host information from the smart device to a host entity system via a network communication interface; and
communicating resource distribution information from the smart device to a third party system via the network communication interface where the third party system is different than the host entity system, the resource distribution information usable by the third party system to distribute a resource to the host entity system.

18. The method of claim 17, wherein the resource distribution information comprises a secured request requesting a payment to the host entity system.

19. The method of claim 17, comprising generating a signal used to initiate the secured request.

20. The method of claim 17, comprising using logic to initiate the secured request.
